(19) United States
(12) Patent Application Publication
(10) Pub. No.: US 2003/0048931 A1
(43) Pub. Date: Mar. 13, 2003

(54) Quantification and differentiation of tissue based upon quantitative image analysis

(76) Inventors: Peter Johnson, Wexford, PA (US); Othman Abdulkarim, Pittsburgh, PA (US); Michael Fuhrman, Pittsburgh, PA (US); Mark Disilvestro, Fort Wayne, IN (US); Ronald Stone, Pittsburgh, PA (US); Mark Braughler, Upper St. Clair, PA (US)

Correspondence Address: Louis M. Heidelberger, 2500 One Liberty Place, 1650 Market Street, Philadelphia, PA, 19103, US

(21) Appl. No.: 10/106,582

(22) Filed: Mar. 25, 2002

Related U.S. Application Data
(60) Provisional application No. 60/278,288, filed on Mar. 23, 2001.

(51) Int. Cl. G06K 9/00; G06K 9/46; G06K 9/66

(52) U.S. Cl. 382/128; 382/190

(57) ABSTRACT

We disclose quantitative geometrical analysis enabling the measurement of several features of images of tissues including number, size, density of extracted hepatocyte nuclei, and other metrics. Automation of feature extraction creates a high throughput capability that enables analysis of histologically prepared tissue sections for accurate quantification of extracted features from tissues. Measurement results are input into a relational database where they can be statistically analyzed and compared across studies. As part of the integrated process, results are also imprinted on the images themselves to facilitate auditing of the results. The analysis is objective, fast, repeatable and accurate and provides an alternative or supplement to the subjective analysis of tissue slides by a pathologist.

This application claims priority to application No. 60/278,288 filed Mar. 23, 2001, and the text of application No. 60/278,288 is incorporated by reference in its entirety herewith.

### FIELD OF THE INVENTION

The present invention generally relates to characterization of tissue for the creation of data and associated images (“tissue information”) suitable for a robust, relational database that manages the input and retrieval of such information needed to perpetuate the tissue information for comparison and combination with tissue information obtained through studies taking place at different times, with different protocols and with measurements made by different systems. The present invention specifically relates to a system and method of analyzing tissue specimens in an automated and objective manner, which system and method improves upon, or substitutes for, the present manner of non-automated and subjective analysis of tissue specimens.

### BACKGROUND OF THE INVENTION

Accurate and repeatable quantitative analysis of tissue is important to characterize the progression of various pathologies, and to evaluate effects that new therapies might have. To date, little, if any, reliable structural information exists at the tissue level (1-1000 microns, that is, in the range microscopic to mesoscopic). It is believed that if reliable, multi-dimensional tissue structural information existed in readily accessible databases capable of continuous assimilation with newly acquired information, including clinical and molecular (including genetic) information, such information would serve to enhance and accelerate new advances in tissue engineering, drug design, gene discovery, proteomics, and genomics research.

The present invention overcomes the problems of the current art. Present visual/manual analysis of tissue is slow, difficult, prone to error, and subjective. The analytical approach of visual observation of tissue specimens by a person, however skilled, is limited to broad screening, such as the distinction between normal and abnormal tissue. As one weakness of the present approach, quantifiable differences among tissue termed “normal” may be overlooked and the diagnostic significance lost. The present invention is directed to an automated and objective approach to tissue analysis. Numerous tissue parameters may be obtained, quantified, and analyzed. Subtle differences in tissues qualitatively labeled by a pathologist as normal are identified by use of the automated, objective approach of the present invention. For example, statistically significant differences were articulated by comparing the number, size and density of extracted hepatocyte nuclei among sets of pooled samples from three different livers labeled as “normal” by a pathologist. Disclosed herein are image processing and analysis methods to automate feature extraction from tissue and to enable an objective, quantitative definition of tissue. Measurement results are input into a relational database where they are statistically analyzed and compared across studies.

### SUMMARY OF THE INVENTION

The present invention is directed to analysis of tissue and the creation of a database that includes characterization data and associated images (“tissue information”) representative of a tissue population, an automated method to create such database, and the use of the database for classification and evaluation of tissue specimens to allow an automated and objective method of distinguishing between normal and abnormal tissue. In an embodiment of the present invention, samples of normal tissue specimens obtained from a subset of a population of subjects with shared characteristics are profiled in order to generate a plurality of structural indices that correspond to statistically significant representations of tissue associated with the population. In a study of sets of pooled samples from three different livers all labeled as “normal” by a pathologist, statistically significant differences were found when comparing the number, size, and density of extracted hepatocyte nuclei.

The present invention is also directed to a method for classifying tissue specimens, comprising the steps of capturing images of the tissue specimens, identifying features within the tissue specimens, measuring parameters associated with the features of the tissue specimens and storing said parameters, wherein a plurality of the steps are automated. This classification may be directed toward quantifying differences in parameters between tissue subjectively classified as normal from tissue subjectively classified as abnormal, or it may be directed toward quantifying differences among tissues all subjectively characterized as normal or among tissues all subjectively characterized as abnormal.

In a particular embodiment, the invention is directed to an accurate and repeatable analysis of the number, size, and density of extracted hepatocyte nuclei among sets of pooled samples from three different livers all labeled as “normal” by a pathologist. The steps of the automated method involve capturing images, assembling images, extracting features, identifying boundaries, areas, centers of mass, shape, orientation, circularity, and nearest neighbor distances of the features, and placing results and images into a database for easy retrieval and statistical analysis.

### BRIEF DESCRIPTION OF THE DRAWINGS

FIG. 1 shows quantitative analysis of rat liver (normal) tissue.

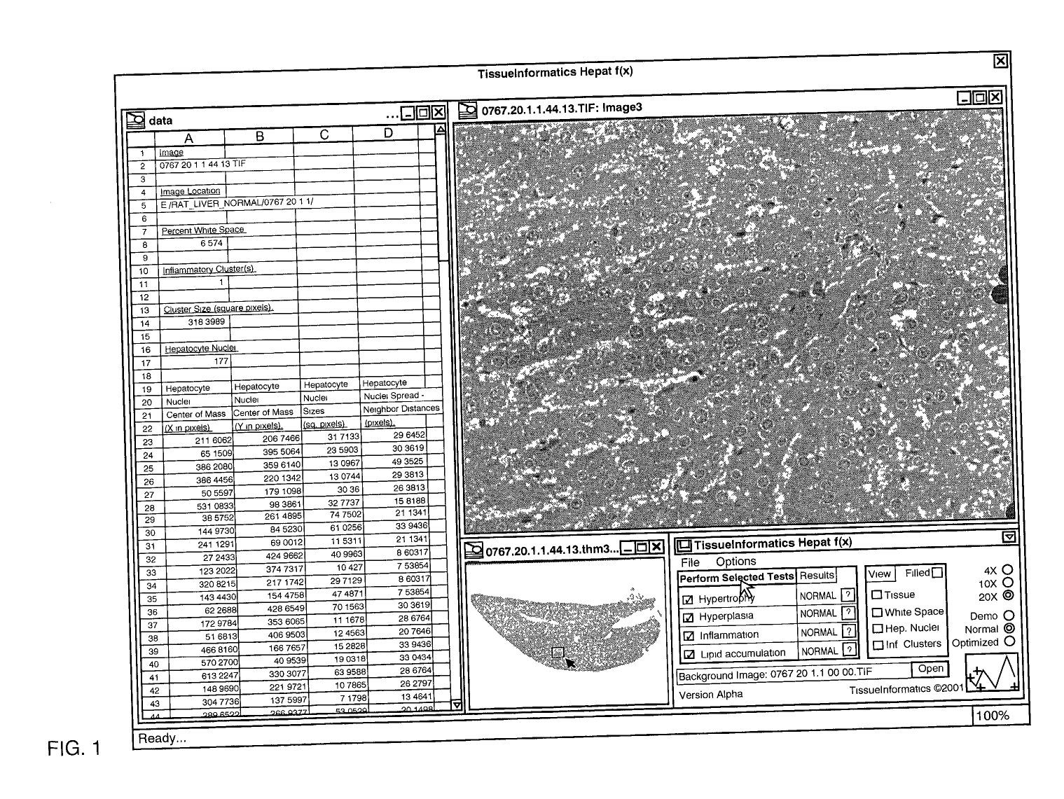

FIG. 2 shows our illustrative example of database query to find images and the tissue feature data that match the query criteria.

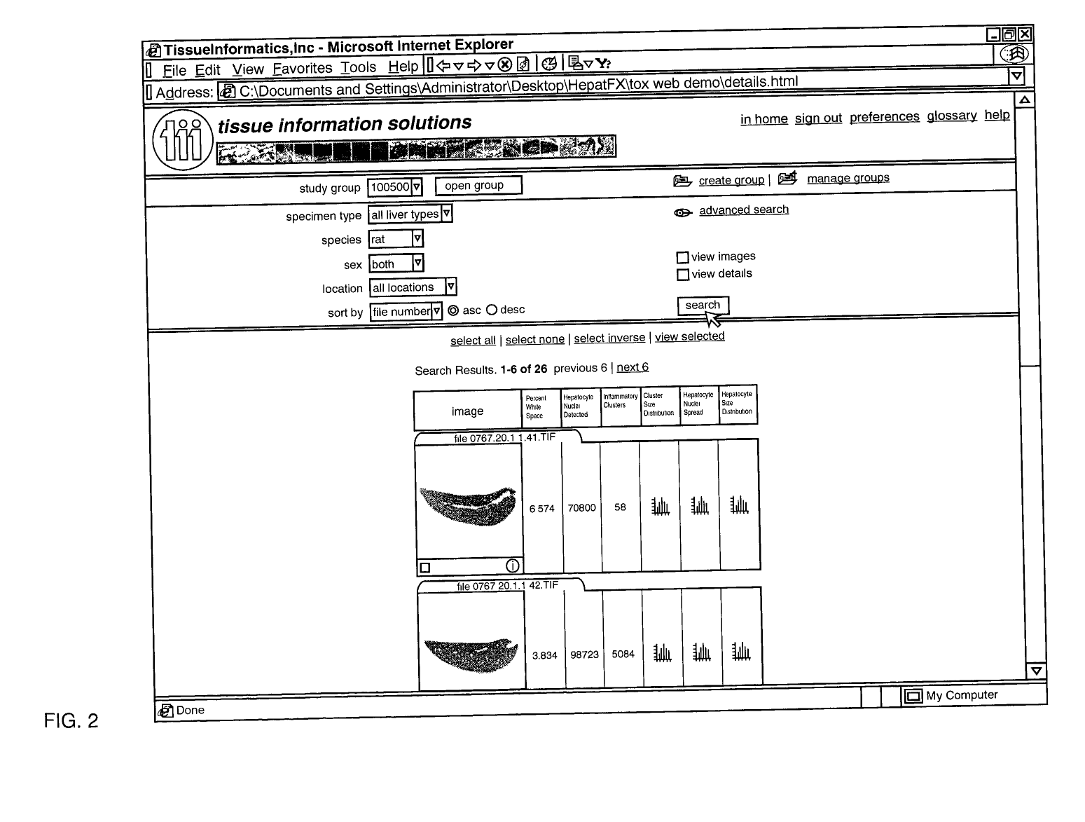

FIG. 3 shows rat liver (normal tissue) hepatocyte nuclei distribution.

FIG. 4 shows rat liver (normal tissue) hepatocyte nuclei number per mm.

FIG. 5 shows rat liver (normal tissue) hepatocyte nuclei size.

FIG. 6 shows rat liver (normal tissue) hepatocyte nuclei nearest neighbor distances.

### DETAILED DESCRIPTION OF THE INVENTION

The present invention represents a novel approach to an automated measurement and analysis system to quantitatively evaluate tissues while reducing the uncertainty, imprecision, time, and subjectivity involved in making manual measurements. The present invention is directed to a robust database that is based upon input parameters that may be uniformly investigated and extracted from different studies. The present invention is directed to a database that allows input and retrieval of data and images needed to compare studies taking place at different times, with different protocols, and with measurements made by different systems. The present invention is directed to a database which preserves the utility of the stored information through continued lossless combination and comparability with subsequently acquired information and the accessibility of the stored images for automated re-analysis.

Embodiment of Liver Analysis

Feature Identification/Source of Quantifiable Parameters

In an analysis of liver tissue, the following pathologies can be studied in liver tissue specimens from which quantifiable features can be identified and extracted for an automated and objective tissue analysis. These quantifiable features can be made parameters in a database.

List of Pathologies

1. Necrosis (cell death)

a. Single cell (spread out; diffuse)

b. Coagulative/extensive/multicellular (many defining a necrotic area)

2. Hypertrophy (individual hepatocyte enlargement—usually centrilobular)

3. Inflammation (clusters)

a. Neutrophilic

b. Mononuclear (macrophages, lymphocytes)

c. Granulomatous (fibrosis, larger clusters with less dark nuclei and more cytoplasm around the nuclei—nuclei not as close together)

4. Hyperplasia (hepatocyte proliferation)

5. Lipid accumulation within hepatocytes

6. Hydropic accumulation within hepatocytes

7. Mitotic activity

8. Fibrosis (fully developed connective tissue surrounding the portal triad)

9. Fibroplasia (developing connective tissue surrounding the portal triad)

10. Pigment accumulation

a. Bile pigment—need high magnification to see this

Associated Quantifiable Features

1. Necrosis (cell death)

a. Cell cytoplasm color change (more pink or more washed out)

b. Nuclei change (very dark or washed out)

c. Report:

i. # of necrotic cells/unit area for single cell necrosis

ii. # of closed necrotic areas/ratio of necrotic areas to total tissue area

2. Hypertrophy (individual hepatocyte enlargement)

a. Increase in cell area

b. Increase in nuclei area (unreliable)

c. Decrease in the ratio of nuclei area to the cytoplasm area

d. Report:

i. nuclei size distribution

ii. cell size distribution

3. Inflammation (clusters)

a. Neutrophilic OR mononuclear

i. Basophilic staining structures clustered together

ii. Shape of nucleus at 10/20×is round=mononuclear

iii. Shape of nucleus at 10/20×is multilobule (U-shaped)=neutrophilic

b. Granulomatous

i. Less dark nuclei

ii. More oval shaped nuclei

iii. More cytoplasm so clusters are less easily visible as dark clumps

c. Report:

i. # of inflammatory clusters

ii. type of inflammatory clusters

iii. size of inflammatory clusters

iv. ratio of inflammatory cluster area to total tissue area

4. Hyperplasia (hepatocyte proliferation)

a. Increased number of nuclei

b. Increased ratio of total cytoplasm area (pink) divided by the number of nuclei (approximate cell number)

c. Report:

i. # nuclei per unit area

5. Lipid accumulation within hepatocytes

a. Increased white space with accompanying round white vacuoles inside hepatocytes

b. Report:

i. # vacuoles per unit area

6. Hydropic accumulation within hepatocytes

a. Increased white space with accompanying non-round white vacuoles inside hepatocytes

b. Report:

i. # vacuoles per unit area

7. Mitotic activity

a. Special stain necessary

b. Condensed nucleus

c. Report:

i. # of each type of mitotic nucleus

8. Fibrosis (fully developed connective tissue surrounding the portal triad)

a. Striated tissue surrounding the portal triad(s) in a circumferential pattern

b. Report:

i. Fibrotic area/tissue area

9. Fibroplasia (developing connective tissue surrounding the portal triad)

a. Striated tissue surrounding the portal triad(s) in a circumferential pattern

b. Report:

i. Fibroplastic area/tissue area

10. Pigment accumulation

a. Bile pigment—need high magnification to see this

i. Gold-brown color between hepatocytes

In a particular embodiment, details of the digital image capture and quantitative analysis of rat liver tissue sections are described. Liver is chosen as an emodiment, because liver is a primary locus of drug metabolism and a tissue where drug toxicity is most frequently observe. Quantitative histological information about hematoxylin and eosin stained liver tissue and software that can do this analysis are the focus here.

The first step in providing quantitative histological information about liver for screening and tissue analysis is the digital image capture of an entire liver section. Many slides containing liver sections can be automatically imaged at sufficient resolution to repeatably detect features of interest. As shown here, many digital image captures, merged together into a seamless digital image montage, are required to create a complete digital image of an entire liver section. The complete image montage is archived in a database and available for image analysis, which is demonstrated next.

Automated image analysis techniques are used to extract features of interest from each digital liver section. Here, a single image capture associated with the liver section, shown as a thumbnail at the bottom of the screen, undergoes such image analysis. Features including hepatocyte nuclei, white space, and potential inflammatory clusters are automatically extracted. Data from these features such as their number, location, size, and density are instantly calculated and placed into a relational database.

After image analysis, the information-rich database can be queried. Each user can have an individual login name and password to limit access to the data as required. General and customized fields such as “specimen type” can be generated and used as query tools. A search can be performed to find only images that match the query criteria or a search can be performed to find both the images and the associated data from image analysis. Images in the database can be retrieved, and the computer can be used as a microscope with complete zoom and pan capabilities, allowing each individual image capture to be evaluated. Features detected during image analysis can be shown as overlays. Also, the data from image analysis can be mined and histograms of the data arrays can be produced.

Tissue Section and Digital Image Capture Details are as follows: Rat livers are obtained at time of sacrifice. The liver section is prepared by a histotechnician (a single slice is taken longitudinally through the tissue, embedded in a paraffin block, and microtomed). The section thickness varies between 3-10 microns. The section is stained with hematoxylin and eosin. The slide containing the section is placed under a Nikon E600 microscope and imaged using a Prior Model 101 automated microscope stage and a Sony DKC-ST5 digital camera. A background image is also taken. Imaging occurs with bright field illumination under a 10× magnification at low resolution (1.3 micron/pixel). The tiles are trimmed by 5 pixels around the edges resulting in a tile size of 630×470 pixels. These tiles are stitched together (shade correction is performed based on the background image, and the tiles are laid side by side to form the entire digital liver section).

The pathologist may only have the ability to control the software selection criteria for “Normal” slides. In the presnet invention one can load slides in cassettes and place them in the device, initialize the product and walk away. Slides can be individually loaded onto an automated stage that will record the corresponding slide and cassette number using a barcode scanner, capture all of the sections on the slide, and return the slide to the cassette. These digital images will be saved in a database along with the barcode information.

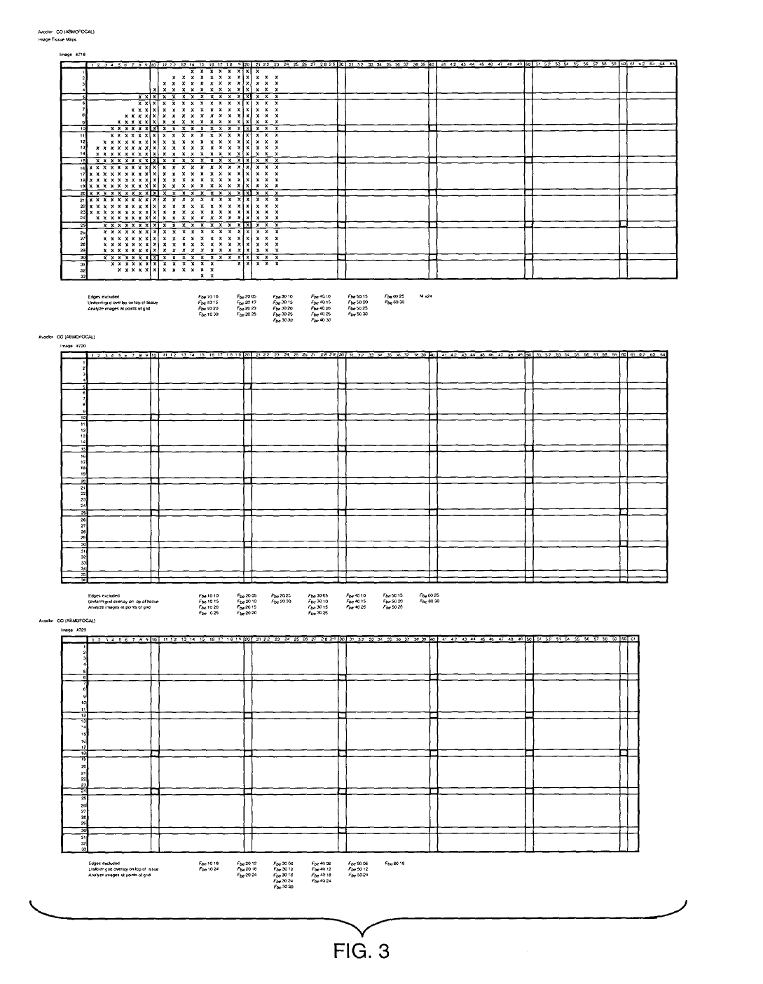

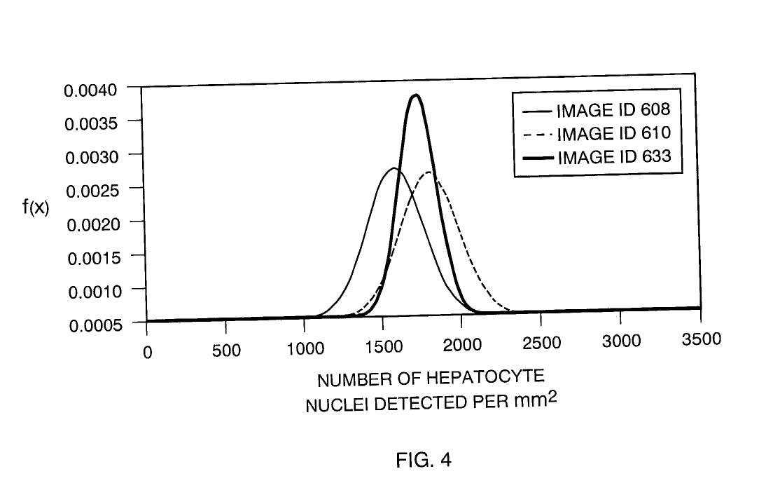

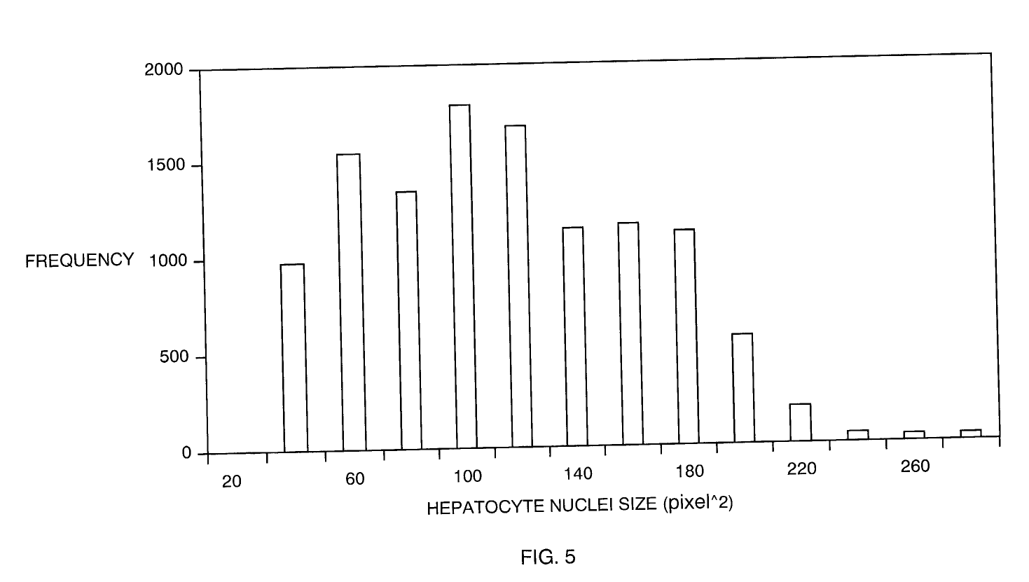

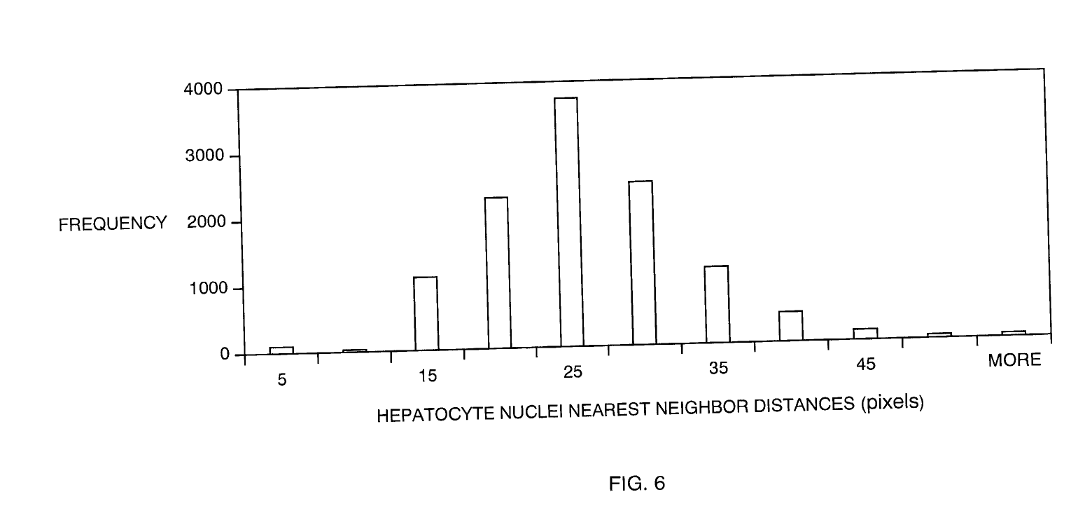

Image analysis can be performed on each digital tissue section using the software to evaluate drug toxicity, for example. The software can use color detection algorithms followed by morphological segmentation methods to extract the features listed above. The quantitative measures resulting from this analysis can be used to determine the state of the tissue section as “Normal” or “Abnormal”. This data can also be saved in the database. The database can allow input from the pathologist as to the final diagnosis of each “Abnormal” tissue section. The database can be easily queried allowing the correlation between quantitative tissue information, drug, donor information, and the qualitative information supplied by the pathologist. In another aspect, the invention relates to generate data comparing different normal tissues (statistically different) to be able to distinguish between different “normals” as qualitatively labeled by a pathologist using the software ability to distinguish between “normals” without quantitative image analysis software (see FIGS. 3 to 6 which show the differences of rat liver hepatocyte nuclei distribution, hepatocyte nuclei size hepatocyte nuclei nearest neighbor distances within the three normal rat liver samples).

Generally, the pharmacokinetic, pharmacodynamic, and toxicologic properties of a drug or drugs must be evaluated and documented in laboratory animals before study in humans. One skilled in the art knows how to chose laboratory animals for drug testing studies. In an aspect of the present invention, a method for screening tissues for drug toxicity are disclosed. In this method, tissues (e.g., liver, kidney or lung) from animals treated with a given drug and corresponding tissues from untreated animals are obtained. Tissues from untreated animals or control animals are considered to be normal or control tissues. Tissues from treated animals, to the extent that these tissues show toxic effects due to the drug(s) (which effects can be determined by making comparisons to the controls) are considered abnormal tissues. One skilled in the art would know how to set up animal screening tests for drug toxicity. Tissue sections of selected tissues are analyzed according to the present invention and quantitative features are determined.

Details of Liver Embodiment

A number of structural features, such as number, area, distribution of cells (distinguished by type), and extra-cellular materials, within both normal and pathological liver tissue can be visualized with haematoxylin and eosin. These features include, but are not limited to, hepatocyte nuclei, other nuclei (Kupffer cell nuclei, Ito cell nuclei, inflammatory cell nuclei), sinusoids, vacuoles, and necrotic areas. Quantitative information pertaining to these specific structural features will provide pathologists with valuable information assisting them in making diagnoses. Prior applications of image analysis techniques to digital images of stained tissue specimen have been limited to measures of single structural features. We disclose image analysis techniques which provide information on a plurality of structural features. Pathologists' knowledge has provided the development effort with insight into the key differentiators of each of these structures. The development process followed well-known image analysis procedures. Each structure was identified visually within a number of images representing both varying preparation methods and varying disease states. The method disclosed herewith has been applied to a number of haematoxylin and eosin stained tissues obtained from multiple donors presenting both normal and diseased states. The method is robust enough to handle variability in structural features between normal and diseased states.

One embodiment of the present invention is a method by which the location and quantification of features of interest, such as structural features, may be automated wherein the method comprises a step of utilizing a set of stained tissue specimens from multiple donors and the pathological classification of specific features visible within the specimens, such that certain regions in the image are known to represent specific features, such as hepatocyte nuclei or necrotic tissue. One embodiment of the present invention is a method of image segmentation followed by sub-differentiation comprising a step of applying morphological thresholds. The application of thresholds may be in cascading sequence. This includes a method comprising a step of applying a cascade of measurement thresholds by which one feature (for example, structural) is selected from a background image (or other features). An example of a threshold might be a certain value for cell area, eccentricity or circularity, which value might be selected through experimentation to optimize observation or detection of certain structural features. One embodiment of the present invention is a method comprising a step of applying a plurality of measurement threshold values, which threshold values are selected through experimentation to optimize observation of a structural feature of interest, wherein the measurement threshold values are applied sequentially to make objective determinations to filter out areas of the tissue specimen unlikely to contain the structural feature of interest. One embodiment of the present invention is a method of image analysis comprising the steps of quantifying structural features and differentiating tissue morphologies. Steps of the different embodiments may be combined to form other embodiments.

Information about the background image including the mean and standard deviation values of all pixels present in each of the three bands (red, green and blue) is first gathered. This information is used to shade correct each color image of tissue. The image is then segmented to identify the above-mentioned structural features.

The general process of segmentation involves separation of the original color image into individual bands, including, but not limited to, red, green, blue, hue, saturation, and intensity bands. The visual presence or absence of each respective feature, class of features, or subclass of features was evaluated in each of the individual bands. A process of experimentation selects the optimal band that identifies each feature, class of features, or subclass of features. A process of comparison is employed, guided by the pathologist's ability to distinguish one tissue component from another through visual inspection of the image of the stained specimen, to select a segmenting criteria that appears broad enough, but not too broad, to include the portion of the image that includes the feature of interest.

Thresholding methods are developed experimentally enabling robust segmentation of each structure or class of structures based on intensity within the selected band. Finally, optimized classification methods are developed to identify each of the important structural features.

The method for developing automated feature identification and quantification may involve a cascading sequence of segmentation. Within a given tissue-containing image, first necrotic areas are segmented. Through experimentation, the saturation band of the original color image is selected, using standard image analysis tools. The histogram of the saturation band is calculated via a presentation of distribution of pixels according to the particular differentiation criteria, and the total number of pixels from 0 to the mean of the histogram minus the standard deviation of the histogram divided by two is calculated (to define the area of necrosis appearing in the tissue to exclude the area from further analysis). The number of pixels calculated is divided by the total number of pixels in the image, and a percent of “possible necrosis” is found. If this percentage is larger than a prescribed parameter (that, through experimentation, demonstrates that the number of pixels calculated will include all of the area interpreted to represent necrotic tissue in the image), the following necrotic area segmentation is performed. The image is thresholded from 0 to the mean minus the standard deviation of the saturation histogram. The resulting objects are binarized (i.e., converted to a black/white scale), filled (i.e., shapes with incomplete boundaries are enclosed), and a close operation is performed. The boundaries of the resulting objects are extracted (i.e., measured) and those objects larger than a prescribed cutoff parameter are classified as necrotic areas.

The areas identified as necrotic areas are excluded from further segmentation eliminating the possibility of including structural features within necrotic areas among features identified and quantified thereafter. An embodiment of the invention is a method comprising a step of excluding selected areas of a tissue specimen from further analysis or segmentation. A specific embodiment of the invention is a method comprising a step of excluding necrotic area from consideration for analysis of certain structural features.

Red cells and blood-filled objects are next segmented by thresholding the original color image from 0 to the mean plus the standard deviation of the histogram in the red band (a measure of the distribution of pixels of the image within the band) from 0 to the mean minus the standard deviation of the histogram in the green band (a measure of the distribution of pixels of the image within the band), and from one half of the mean to the mean minus the standard deviation of the histogram in the blue band (a measure of the distribution of pixels of the image within the band) All resulting objects are classified as red cell objects.

Next, all serum-filled and white colored objects are segmented. Through experimentation, this segmentation was accomplished by thresholding from the mean to the mean plus the standard deviation of the histogram in the green band. All resulting objects are classified as serum objects.

Next, dark objects are segmented from the red band by thresholding from 0 to the mean minus the standard deviation of the histogram in the red band.

Once certain groups of objects are identified through image segmentation, further differentiation within those groups is achieved by applying morphological parameters. There parameters are optimized experimentally. If red cell objects are found, single red blood cells are classified as red cell objects with sizes between two specified parameters. Similarly, if red cell objects are found, large blood vessels are classified as red cell objects larger than a specified parameter Also, if serum objects are found, those serum objects larger than the same size parameter are classified as large blood vessels, as large blood vessels can be filled with serum, blood, or empty in histological sections.

All large blood vessels are recreated and dilated a number of times specified by the user The resulting area is classified as the boundary of all large blood vessels. This enables error to tend toward finding more large blood vessels, rather than missing some. (meaning that the method is oriented to select false positives)

If red cell objects, serum objects, and dark objects are found, the three areas are recreated and filled. A close operation is performed (to complete the boundaries of all identified objects), and the resulting areas that are larger than a prescribed parameter are classified as portal tracts. If portal tracts are found, these objects are recreated and dilated a number of times specified by the user. The resulting area is classified as the boundary of all portal tracts. This enables error to tend toward finding more portal tracts, rather than missing some. (meaning the method is oriented to select false positives).

If dark objects are found, these are recreated and filled. If any of these has an area larger than a prescribed parameter, it is labeled as a tissue fold (meaning a fold of the tissue specimen). All tissue folds are recreated alone and dilated a number of times prescribed by the user. All necrotic areas, large blood vessel areas, red blood cell areas, portal tract areas, and tissue fold areas are excluded from further segmentation and classification.

For both hepatocyte nuclei and other nuclei, the red band is selected as the ideal band for segmentation, and segmentation is performed by classifying all pixels with values between 0 and the mean minus the standard deviation of the histogram in the red band. If selected by the user, double nuclei (peanut shapes) (meaning something shaped like a peanut) are separated using predetermined size and eccentricity thresholds (the size threshold is set to a predetermined area; the eccentricity threshold measures the deviation of the shape from a perfect circle) Also, if selected by the user, a convex hull can be performed to ensure that only convex shaped nuclei are identified. Nucleus classification is performed by plotting the standard deviation of the intensity values within each nuclei object versus its respective size, and separating the plot into two groups either manually or automatically by maximizing the cluster distance between the two groups and generating a line between their centroids.

Serum areas are segmented from the green band by thresholding from the mean plus the standard deviation of the histogram in the green band to a particular number, such as 255. (in one standard for color segmentation, 0 is black and 255 is white). These serum objects are classified into either serum-filled sinusoids or vacuoles. The classification of the serum objects is performed morphologically by classifying vacuoles as serum objects with circularity values less than a prescribed parameter. Thus, an embodiment of the present method may include a step in which image analysis establishes morphological differentiation.

Serum-filled sinusoids and blood-filled sinusoids are combined to form the set of identified sinusoids.

Software Package

1. The software package allows a user to open a background image or to select both a background image and a current image.

2. The software performs all of the feature extraction (find the tissue, detect white space, detect nuclei (including heptacyte nuclei and potential inflammatory clusters),

3. The selected tests are performed searching for possible hypertrophy, hyperplasia, and inflammation.

4. After the tests are performed, automated analysis of parameters allows a determination of whether the tissue is normal or abnormal.

5. All features which had been checked are automatically displayed. Numeric parameters are given.

6. The numeric parameters for the given tissue specimen may be compared to analogous parameters for results of other normal or abnormal tissue in the database.

What is claimed is:

1. A method for classifying tissue specimens, comprising the steps of
capturing images of the tissue specimens;
identifying features within the tissue specimens;
measuring parameters associated with the features within the tissue specimens; and
storing said parameters in a database, wherein at least the step of capturing images is automated, wherein said method allows an automated and objective method of determining whether a tissue specimen is normal.

2. A method for classifying tissue specimens, comprising the steps of
capturing images of the tissue specimens;
identifying features within the tissue specimens;
measuring parameters associated with the features within the tissue specimens; and
storing said parameters in a database, wherein at least the step of capturing images is automated, wherein said method allows the quantification of differences in parameters within a set of tissues subjectively characterized as normal by a pathologist.

3. A method for screening a tissue specimen to evaluate drug toxicity, the method comprising:
(a) imaging a first tissue specimen of a given tissue type of an animal exposed to a given drug and creating a digital image of the first tissue specimen;
(b) imaging a second tissue specimen of the given tissue type of the animal not exposed to the given drug and creating a digital image of the stained tissue specimen; and
(c) extracting a given plurality of features from the digital image in steps (a) and (b); and
(d) comparing the given plurality of features extracted from the digital image in (a) with that of (b) to determine effect of drug toxicity on the first tissue specimen.

4. The method of claim 3, wherein the given tissue type is liver tissue.

5. The method of claim 4, wherein the given plurality of features comprise all types of nuclei, all types of white space and all red cells.

6. The method of claim 5, wherein all types of nuclei comprise normal hepatocyte nuclei necrotic hepatocyte nuclei and lymphocyte nuclei.

7. The method of claim 5, wherein all types of white space comprise sinusoids, vacuoles, water vacuoles and lipid vacuoles.

8. A method for screening a tissue specimen to evaluate drug toxicity, the method comprising:
(a) analysing a first tissue specimen of a given tissue type of a first animal exposed to a given drug and quantifying a selected quantifiable feature;
(b) analysing a second tissue specimen of the given tissue type of a second animal not exposed to the given drug and quantifying a corresponding quantifiable feature; and
(c) comparing the differences between the selected quantifiable feature in (a) and the corresponding quantifiable feature in (b) to determine said drug toxicity.

9. The method of claim 1, wherein said quantifiable feature is selected from the group consisting of: hypertrophy, hyperplasia and necrosis.
